(19) United States
(12) Patent Application Publication
(10) Pub. No.: US 2019/0066504 A1
(43) Pub. Date: Feb. 28, 2019

(54) System for automatically determining the position and velocity of objects

(71) Applicants: George Zaloom, Pacific Palisades, CA (US); Alex Perez, Littleton, CO (US)

(72) Inventors: George Zaloom, Pacific Palisades, CA (US); Alex Perez, Littleton, CO (US)

(21) Appl. No.: 16/003,314

(22) Filed: Jun. 8, 2018

Related U.S. Application Data
(60) Provisional application No. 62/521,487, filed on Jun. 18, 2017.

(51) Int. Cl. G08G 1/14; G08G 1/127; H04W 4/40; H04W 4/02; H04W 4/029

(52) U.S. Cl. CPC G08G 1/144; G08G 1/127; H04W 4/029; H04W 4/027; H04W 4/40

(57) ABSTRACT

A ground based wireless system named the Autonomous Transceivers Positioning System (“ATPS”), performs complete autonomous tracking of multiple moving objects and determines position and velocity components (speed and direction) of a moving object, or the stationary position of an object. For a moving object, the ATPS provides position determination, with accuracy of several centimeters, and velocity determination with an accuracy of centimeters per second. The ATPS tracks the position of multiple objects simultaneously and continuously for as long as the object(s) reside within the workspace of the ATPS wireless system. The ATPS is expandable in its workspace continuously by allowing for tracking information to be autonomously handed over to new added sections of the ATPS. The ATPS contains RFID inspired components including advanced multiple fixed location Autonomous Wireless Interrogators (“AWIs”) within the defined workspace of the system and multiple Autonomous Wireless Responders (“AWRs”) affixed to the moving and/or stationary objects.

### CROSS-REFERENCE TO RELATED APPLICATIONS

The present application claims priority to U.S. provisional patent application Ser. No. 62/521,487, filed on Jun. 18, 2017, entitled “System for Location Determination Using advanced RFID Technology,” which is hereby incorporated by reference in its entirety.

### BACKGROUND

Over many years now the desire to know the position of a mobile object has been the subject of research, publications, patents, and development of intellectual property and trade secrets. The early efforts in position knowledge were limited by technology. The tools for the knowledge of position determination are mostly of “static” nature. That is, the position of a mobile object (which may herein be referred to as a “mobile”) is known at a specific time and place after some measurements are made. After a certain length of time has elapsed, measurements are taken again, and the new position of the mobile is recorded. An example of static measurements for position determination is that of imaging satellites, which are still widely used today. Using an imaging satellite, the location and characteristics of a certain target are acquired when the satellite passes over the target, and are acquired again when the satellite passes over the target a few hours later. The motion of the target, if any, is then measured by correlating the previous and after images to determine the target displacement.

Much more recent technology for tracking the positioning and movement of targets has been in the form of RFID technology. U.S. Pat. Nos. 8,629,762, 8,838,135, 8,842,013, 8,866,615, 9,291,699, 9,332,394, 9,338,606, 9,472,075, and 9,619,679 are based on RFID technology. Using RFID technology, the moving object is first affixed or tagged with a passive tag and the object movement is then tracked using active RFID tags located at strategic locations throughout a workspace of interest where the object will move about. This is considered a “dynamic” positioning determination. As the objects moves along, and the passive RFID transceivers communicate with the active RFID transceiver, the locations of the objects are registered. Only through the dynamic interlocking of communications between the RFID transceivers can the positions of moving objects can be known. Many of previously filed and issued patents use different techniques or modalities of dynamic position determination. Another example of dynamic positioning technology is in the use of laser technology (U.S. Pat. Nos. 8,565,913 and 9,360,300). Other previously filed and issued patents disclose developing technologies that make different attempts at methods for position determination using a combination of existing technologies such a mobile computing (U.S. Pat. Nos. 9,043,069, 9,177,476), parking technology (U.S. Pat. Nos. 8,395,968, 9,064,414, 9,123,034), and a variety of sensors, radars, range finders, communications devices such as cell phones and other handsets, navigational aids, and other RF transmission devices (U.S. Pat. Nos. 8,284,100, 8,428,913, 8,442,482, 8,725,416, 8,929,913, 8,954,292, 9,071,701, 9,094,816, 9,339,990, 9,295,027, 9,369,838, 9,373,241, 9,386,553, 9,485,623, 9,641,978, 9,734,714, 6,501,955, 5,379,047, 6,021,371, 7,489,240, 6,907,224, 9,749,780 and others).

Presently, the most advanced and most popular positioning determination method for mobiles or stationary objects is the Global Position System (GPS) as shown in U.S. Pat. Nos. 8,478,299, 9,274,232, and 9,612,121. GPS is categorized herein as a “continuous” positioning determination method, and it has been available to the public for several years now. Continuous position determination means that an object with GPS technology can be continuously tracked and its position can be determined without any elapsed time if the object can continuously receive GPS signaling from GPS satellites. Therefore, for GPS technology, continuous tracking is dependent on the uninterrupted availability of GPS received signals.

Current geo positioning applications such as GPS, rely on four satellites to triangulate their location. For the most part, these systems return accurate results except when operating within the cement canyons of densely populated cities and geographic obstructions. In densely populated cities, buildings' “shadows” make it difficult for the Global Navigation Satellite Systems (GNSS) to perform accurately. Without continuous direct received signals from four or more GPS satellites, a precise positioning cannot be determined.

The positional accuracy of a GPS system, assuming no fading and multipath, is on the order of 15-30 feet. In congested structural environments GPS signals have troubles being acquired. The technology for position determination using GPS is based on the time of arrival (TOA) and the time of reception (TOR) of the GPS signal by the GPS receiver and the triangulation of the four GPS received signals. There can't be any lapse in TOA and TOR if continuous position determination is desired.

To compensate for the deficiencies in signal coverage due to physical obstructions in the environment, and to improve the accuracy of GPS positioning technology, a strategy known as “differential GPS” is used, where corrections are made to the measurements by a mobile receiver (user) by using as reference the measurements done by the nearest fixed GPS base station using the same four GPS satellites.

In a cellular phone system where mobiles (e.g., people) are equipped with cellular technology and the cellular technology is equipped with GPS receivers, as the mobile object moves, the GPS differential position of the mobile unit also moves. The mobile unit can move through an extensive route and the cell towers will track the GPS position along the route. The “hand-over” of the tracking from one cell tower to the next occurs when the signal strength received at one tower decreases as the signal strength received at another tower increases. There is continuous communication among the towers as the hand-over occurs.

However, even with all the advances in GPS positioning technology, GPS can only perform the function of a “beacon” in space. To the user, GPS positioning is nothing more than an electrical beacon overlaid on a geographic information system (GIS) map on the user's mobile device (e.g., the GIS of a Google map on a cellular phone). The only reason this beacon is successfully tracked is because of cellular technology. The two technologies (GPS and cellular) are unrelated, even though they complement each other concerning the subject of positioning.

Therefore, there is a need for a more accurate determination of positioning (presently between 15 to 30 feet as provided by GPS) for a mobile system. It would be ideal to determine the position of an object or a mobile accurately to within several inches or centimeters of uncertainty. A much more accurate position determination of mobiles is needed to: a) avoid collisions among mobiles, b) enable the mobiles to avoid obstacles in their paths, c) enable the mobiles to navigate autonomously. If there is a need for autonomous movement for a mobile (e.g., Google car) there needs to be a great accuracy in the knowledge of mobile location, d) enable the mobile to navigate in congested physical environments and yet be able to distinguish among the paths of different mobiles, and e) enable the mobiles to not always rely on GPS technology, especially when GPS signaling is not available or is being obstructed. It would also be of great advantage for mobiles to decrease their dependency on the effects of shadow issues (e.g., multipath and fading) which are common and obstruct GPS positioning.

There is also a need to establish data communications with the mobile system while the mobile is being tracked, a capability not available in GPS positioning since GPS signaling behaves only as an electronic beacon. For example, an airborne drone can be accurately tracked by a futuristic non-GPS system while at the same time the futuristic non-GPS system can get information about the drone's flight path and the status of its instrumentation. This futuristic system can also provide information to the drone such as in the form of commands or telemetry information.

There is even a foreseen need, which can also be realized, for mobiles to communicate with each other, and within the framework of inter-mobile communications. Furthermore, there is a foreseen need for mobiles to know not only their own position (known as absolute positioning), but also the position of the other neighboring mobiles circulating nearby (i.e., the concept of relative positioning) within a prescribed distance. Finally, there is a foreseen need to measure the speed and relative direction of motion of the mobiles. These three additional capabilities, inter-mobile communication, relative positioning, and velocity components, are not presently available in GPS or any other positioning technology, but they are highly desirable for the technological future of mobile systems.

### SUMMARY

The present invention may include an autonomous transceiver positioning system (ATPS) which provides a ground based autonomous wireless system that accurately determines the position of a moving or stationary object. For a moving object, the ATPS may provide position determination with an accuracy of several centimeters. The ATPS may also provide velocity (speed and direction) determination for a moving object. For a stationary object, the ATPS may provide position determination with an accuracy of several centimeters. The ATPS may be able to track the positions of multiple objects simultaneously and continuously within a defined workspace. The ATPS may include multiple autonomous wireless interrogators (AWIs) on fixed ground locations within a defined space of interest and multiple autonomous wireless responders (AWRs) affixed to the moving and/or stationary objects. The ATPS may use an advanced form of RFID inspired technology such that the AWIs may be able to determine, via hardware and software implementation, the position and tracking of multiple AWRs, and the AWRs may be able to communicate with multiple AWIs. The ATPS may also enable the AWRs to inter-communicate among each other using the AWIs, and the AWIs themselves can also inter-communicate with each other. Therefore, the ATPS may behave as a closed loop system. The coverage of the ATPS is only limited by the numbers of AWIs available and their coverage, and therefore can be expanded to suit an application. Therefore, the coverage of the ATPS is dependent on the coverage of the AWIs. The ATPS, though essentially a closed loop, also has external access points for different external interfaces. These external interfaces enable the ATPS to access the world wide web (WWW) and other future forms of external sources of information.

The ATPS may be an autonomous wireless system that is intentionally deterministic from its creation. All the elements of the ATPS may be for determining the accurate location and tracking of an object in a confined space (also known as a workspace). In the ATPS, location is not determined from the manipulation of incidental knowledge that is available from other existing technologies, including wireless, which serve other purposes. Rather, the ATPS uses advanced technologies to develop new approaches for position determination, which means that all the elements of the technology may be specifically designed for position determination.

The ATPS has the capability of locating and tracking the position of multiple objects (AWRs) simultaneously as they move. In addition to position determination, the ATPS can also track simultaneously the direction of motion of multiple objects and the speed of multiple objects. The number of objects that ATPS can track is limited only by the number of wireless AWIs available in the defined space.

A capability of the ATPS is that the system can facilitate large amounts of data exchanges within a closed loop consisting of AWIs and AWRs. That is, the AWRs being tracked can exchange data among themselves through the wireless AWIs which are tracking the AWRs. In the simplest form, this data exchange consists of information revealing the relative position of one AWR with respect to other AWRs and the velocity vectors for each of the AWRs. Larger volumes of data exchanges can also be achieved among the AWRs and among AWIs. For example, larger data exchanges can be used for providing diagnostics, instructions & commands, and many other types and information with uses that are consistent with the potential different applications.

The AWIs may have nine major sub-systems, and each subsystem may be on a different respective electronic board. All the boards in the AWIs may be interconnected and may include: a) a transceiver sub-system to communicate with AWRs (the transceiver sub-system may also include a GPS receiver); b) a microprocessor-based sub-system to process data, commands, and implement embedded software algorithms; c) a positioning electronic board including electronics responsible for calculating the position and velocity of the AWR transceiver, and having ASIC and FPGA electronics in addition to interface electronics; d) a digital signal processing sub-system to process analog and digital data; e) power supply and power distribution; f) memory; g) an interfaces board to account for multiple interfaces such as remote access, hardware testing, antennas, and externally- and internally-generated data; h) antennas and their feed network; and i) embedded software.

There are many potential applications of the ATPS, but the most significant one is in autonomous vehicles (e.g., airborne drones and self-drive automobiles). Other potential applications include data off-loading from autonomous vehicles, smart parking, guidance of pedestrians with disabilities, social mobile gaming applications where game-play is dependent upon precise geo-location, delivery tracking, emergency services, cell phones and many other applications.

The ATPS is a ground based wireless electronic system with advanced electronic hardware which uses advanced RFID inspired modes (interrogating and responding) of operation. The system includes autonomous wireless transceivers electronics known as interrogators (AWIs). Multiple interrogators (AWIs) work in an ensemble mode to track the position and velocity components (speed and direction) of any object (mobile or stationary) which is equipped with another type of autonomous wireless transceiver electronics known as responders (AWRs). AWIs are stationary and can simultaneously track multiple AWRs. A variety of beamforming antennas and smart antennas are used on the AWIs. In some embodiments omnidirectional antennas are used for AWRs. The number of AWRs that can be tracked is only limited by the number of AWIs available. AWIs are capable of autonomously communicating with each other. AWRs can autonomously communicate with several AWIs. Position and velocity components of AWRs can be accurately measured in cm and cm/sec respectively. A defined workspace for the tracking of AWRs is defined by the number of AWIs available. As the AWRs move through the defined workspace, the AWIs have the capability of autonomously transferring (or handing over) to other AWIs the tracking of AWRs that move within AWIs' workspace. Therefore, the AWRs are always being tracked, but the responsibility of tracking the AWRs changes from previous AWIs to newer AWIs that are closer to the AWRs as the AWRs move along.

The ATPS electronic system described above may enable AWIs to determine the position and velocity of individual AWRs. The AWIs also may be capable of determining the relative position and velocity of AWRs with respect to other AWRs.

The ATPS can facilitate data exchanges within a closed loop consisting of AWIs and AWRs. For example, the AWRs being tracked can exchange data among themselves through the wireless interrogators (AWIs) which are tracking them.

The AWIs in the ATPS may have nine major sub-systems, with each subsystem being represented by an electronic board. All the boards in the AWIs may be interconnected: a) transceiver sub-system to communicate with AWRs. The transceiver also contains a GPS receiver, b) a microprocessor based sub-system to process data, commands, and implement embedded software algorithms, c) the positioning electronic board is the electronics responsible for calculating the position and velocity of the AWR transceiver. It is composed of ASIC and FPGA electronics in addition to interface electronics, d) a digital signal processing sub-system to process analog and digital data, e) power supply and power distribution, f) memory, g) interfaces board to account for multiple interfaces such as remote access, hardware testing, antennas, and external and internal-generated data, h) antennas and their feed network, and i) embedded software.

The ATPS may include certain elements of the embedded software that are of artificial intelligence nature.

The AWRs in the ATPS may have three major components: a) a transceiver system to communicate with AWIs, b) microcontroller system, and c) antennas. The AWRs may be battery powered. Batteries may last about one year on average.

The AWIs in the ATPS may include electronics such as ASICs, FPGAs, control electronics, telemetry, data manipulation, processing and handling, memory management, data storage, smart antennas, and PLC. These electronics are used for all eight major subsystems.

The AWIs in the ATPS may be matched with installation fixtures which enable AWIs to be installed on many types of vertical and horizontal surfaces.

The AWRs in the ATPS may be matched with installation fixtures which enable AWRs to be installed on many types of vertical and horizontal surfaces.

The AWIs in the ATPS may be able to simultaneously track the motions of AWRs up to 100 meters away. The AWIs can track hundreds of AWRs simultaneously.

The AWIs may be approximately the size and shape of a half-gallon milk carton. The AWRs may be the size of, or slightly larger than, a credit card.

The ATPS electronic system can be configured to track the motion of objects in the form of airborne and/or terrestrial autonomous mobile devices. This configuration consists in equipping the mobile devices with AWRs electronics. The AWRs may serve as active tags in the mobile devices moving within the AWIs workspace.

In the ATPS the AWRs may also have passive tags.

The ATPS electronic system may be configured to accurately track the motion of AWRs as they move through the AWIs workspace. As AWRs move away from some AWIs and move closer to other AWIs in the workspace, the task of tracking the AWRs is autonomously handed over from those AWIs farther away to those AWIs closest to the AWRs (the AWIs closest to the AWRs may be those AWIs experiencing higher signal strength when communicating with AWRs). A series of software driven algorithms embedded in all AWIs may be responsible for the handing over process.

Several AWIs in the ATPS electronic system may be connected to the internet. The number of AWIs connected to the internet may be correlated to the size of the AWIs workspace and to the specific application of that workspace. The connection to the internet may be via Wi-Fi signals. Communications among the AWIs may be accomplished via WiMAX, Wi-Fi or W-Fi-direct depending on the availability to the AWIs workspace to access such modes of communications. The communication link between AWIs and AWRs may be at 3.2 GHz.

The AWIs in the ATPS can be remotely accessed for programming and set-up purposes to tailor their functions to the requirements and environments of the AWIs' given workspace.

In certain embodiments of the ATPS, AWIs and AWRs can use different types of directional and omnidirectional antennas instead of smart antennas or in addition to smart antennas. Using directional and omnidirectional antennas may require an increase in the number of AWIs, and this approach may cause an increase in the number of these antennas as well as change in the location and velocity calculations algorithms. Using directional and omnidirectional antennas may also decrease the overall implementation costs. For example, if velocity calculations are not required and only location position is required, smart antennas may not be needed.

In certain embodiments of the ATPS, the AWRs architecture can be a passive tag with no electrical interfaces and only a microcontroller unit instead of a microprocessor-based system. This approach requires only minimum data exchange between AWIs and AWRs.

In certain embodiments of the ATPS, the ATPS can be integrated with cell phone tower base stations where the cell tower accommodates an additional set of antennas for the AWIs, and the cell base station integrates with the additionally needed AWIs electronics.

In certain embodiments of the ATPS, the ATPS workspace can be aggregated in the form of clusters, as in cell phone towers communications, and where communications among the AWIs can be handed over among clusters. This approach may be greatly facilitated if AWIs' locations are as described in the immediately preceding paragraph.

In certain embodiments of the ATPS, the AWRs can be integrated as a feature in cell phones.

In certain embodiments of the ATPS, the location of AWIs within their workspace can be any fixed location that can accommodate solar power or power provided by public utility companies.

The AWIs in the ATPS can communicate and provide data exchange with non-autonomous (e.g., manned) entities which the AWIs may access remotely.

All AWIs in the ATPS may have GPS capability. In certain embodiments some AWRs may have GPS capability.

In certain embodiments of the ATPS, the AWIs and AWRs can not only be used in open spaces but also in closed spaces, such as in parking structures and inside buildings.

In certain embodiments of the ATPS, the locations of the AWIs can be off-ground and the AWRs can be airborne.

The ATPS can be habilitated for many applications such as autonomous vehicles like airborne drones and self-drive automobiles, data off-loading from autonomous vehicles, smart parking, pedestrians with disabilities, social mobile gaming applications where game-play is dependent upon precise geo-location, delivery tracking, emergency services, cell phones and many other applications that require accurate tracking and position determination.

In one embodiment, the invention comprises an arrangement for determining a position of an object within a space. The arrangement includes a first wireless transceiver carried by the object and transmitting a signal including time information. At least four second wireless transceivers are fixedly mounted within the space. Each of the second wireless transceivers receives the signal. At least one of the second wireless transceivers calculates a position of the object based upon the time information and respective times at which each of the second wireless transceivers receives the signal.

In another embodiment, the invention comprises an arrangement for informing a moving object of its position within a space. The arrangement includes a first wireless transceiver carried by the moving object and transmitting a first signal including time information. At least four second wireless transceivers are fixedly mounted within the space. Each of the second wireless transceivers receives the first signal. At least one of the second wireless transceivers calculates a position of the object based upon the time information and respective times at which each of the second wireless transceivers receives the first signal. At least one of the second wireless transceivers transmits a second signal to the moving object indicative of the calculated position of the object.

In yet another embodiment, the invention comprises an arrangement for managing occupancy of a parking area by vehicles each carrying a first wireless transceiver. The arrangement includes at least four earthbound second wireless transceivers associated within the parking area. Each of the second wireless transceivers receives a respective first signal from each of the vehicles occupying the parking area. Each of the first signals includes time information. An electronic processor is communicatively coupled to the four earthbound second wireless transceivers and calculates a respective position of each of the vehicles occupying the parking area based upon the time information and respective times at which each of the second wireless transceivers receives the first signal. It is determined which parking spaces of a plurality of parking spaces within the parking area are occupied by the vehicles. The determining is based on the calculated positions of each of the vehicles occupying the parking area.

### BRIEF DESCRIPTION OF THE DRAWINGS

The novel features of the invention are set forth in the appended claims. However, for purpose of explanation, several embodiments of the invention are set forth in the following figures.

FIG. 1. GPS signals are often blocked in cell phones. In congested physical obstruction areas, a GPS signal is often blocked in a GPS receiver. An example is the loss of GPS signal in a cell phone when the cell phone loses lock with its assigned cell tower in a congested physical environment.

FIG. 2. One of the problems with GPS is that a mobile in transit can fail GPS lock in congested physical environments. Furthermore, the mobile does not know its relative position with respect to other mobile objects.

FIG. 3. Some basic advantages of ATPS over GPS are shown. The figure shows that in addition to accurate positioning of a mobile (more accurate than GPS) the ATPS can perform additional functions not available in the GPS.

FIG. 4. Differential GPS techniques increases the accuracy of user position by receiving corrected positioning data from a nearby receiver base station. The ATPS also makes use an improved type of differential positioning among the AWIs.

FIG. 5. Accurate tracking of the position of an AWR uses multiple AWIs to accomplish serial correction for differential positioning. In the figure four AWIs use differential positioning to track a single AWR. AWIs can track multiple AWRs simultaneously.

FIG. 6. A passanger with a cell phone inside a mobile knows its GPS position (and that of the mobile) because the cell towers that keep track of the cell phone communications are also used to track the GPS receiver inside the cell phones.

FIG. 7. Mobile unit (with an AWR) moving among several AWI units arranged in clusters of four AWIs each. In the figure, four AWIs units are used to track an AWR unit.

FIG. 8. The ATPS system communication capability with WWW is shown via the cloud. In the figure an AWR unit on a mobile is tracked by four AWI units and one of the AWI units communicates with the WWW via the cloud.

FIG. 9. Closed loop communications between the ATPS and other communications venues. In the figure there is closed loop communication system between the ATPS, the internet, and a cell phone such that data flows through each of them in an integrated manner.

FIG. 10. The figure shows basic components of an advanced mobile communication solution using ATPS. The integrated system involves ATPS, personal communications devices, and the WWW.

FIG. 11. Application of the ATPS to a “smart parking” application. AWIs stations are located within the parking area and enable mobiles, equipped with AWRs, to be guided in and out of parking spaces.

FIG. 12. Application of the ATPS to a handicapped blind individual using a “wireless cane” which behaves as an AWR. The AWIs stations provide positioning guidance to a handicapped blind person equipped with a cane containing an AWR.

FIG. 13. An AWI station is simultaneously tracking four AWRs and allowing the Poles to simultaneously exchange data among them.

FIG. 14. Application of the ATPS for traffic monitoring. The ATPS can track the traffic of multiple mobiles in and out of the coverage workspace.

FIG. 15. Overview of AWI hardware architecture. The figure broadly shows the eight major subsystems of the AWI architecture.

FIG. 16. Overview of AWR hardware architecture. The figure broadly shows the main components of the AWR architecture.

FIG. 17. Functional description and associated hardware of the power supply for the AWI. The power supply will provide all the dc voltages required for the operation of the AWI.

FIG. 18. Functional description and associated hardware of the radio frequency (RF) assembly of the AWI. The RF assembly will provide two-way RF communications between the AWI and AWR. It is the only assembly in the AWI that can communicate with the AWR.

FIG. 19. Functional description and associated hardware of the digital signal processor (DSP) assembly. The DSP assembly processes all communications between the AWI and AWR in useful formats and extracts the valuable data which will allow the AWI and AWR to achieve their goals.

FIG. 20. Functional description and associated hardware of the main processor assembly for the AWI. The main processor assembly controls the I/O interface serial data bus and all the data flow in that bus as well as execution of control instructions on the bus for the other AWI assemblies.

FIG. 21. Functional description and associated hardware of the interface assembly. The assembly provides an interface for all externally generated and user provided information to the AWI. It's the AWI interface to the outside world such as the WWW and external users input.

FIG. 22. Functional description and associated hardware describing how the useful data information from each of the AWI and processed by the DSP assembly is used to calculate position, velocity, and direction of motion of an object.

FIG. 23. Functional description and associated hardware for the storage of information (position, velocity, and direction of motion) from multiple objects being continuously tracked by multiple AWI in a continuous manner.

FIG. 24. Functional description and associated hardware for the front end of a smart antenna arrangement (adaptive beam forming) for the simultaneous efficient tracking of multiple objects in motion or stationary.

FIG. 25. Functional description and associated hardware of the AWR.

### DETAILED DESCRIPTION

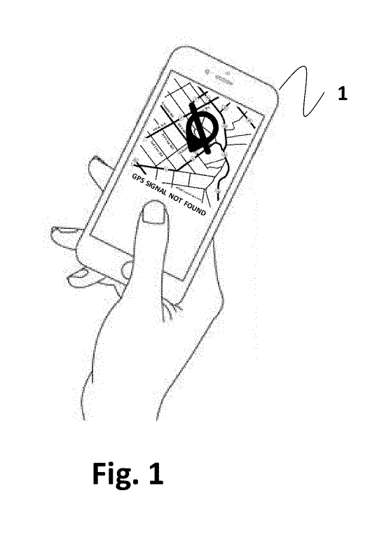

FIG. 1 shows a typical cell phone in its GPS mode, but the phone shows no GPS received signal. Cell phones contain a GPS receiver chip which allows a cell phone user to fix its position on a geographical information map (GIM) with an accuracy of 15-30 feet. The GIM is always part of the geographical information system (GIS) that is being facilitated to the cell phone architecture by cell phone towers closest to where the cell phone is located (i.e. those cell phone towers responsible with communicating with the given cell phone). The accuracy of the geographical positioning provided by a cell phone GPS receiver depends totally on the quality of the GPS received signal from GPS satellites. Inherently, the accuracy of the GPS positioning signaling is only 15-30 feet. However, the accuracy can decrease even further due to the presence of other factors, such as atmospheric environmental conditions, weather, cosmic phenomena, GPS satellite malfunctioning, and physical obstructions on the ground, all of which can prevent a direct line of sight signal between the GPS satellites and the cellular phone. Therefore, not only the accuracy of GPS positioning can decrease, but GPS signals are often blocked and cannot reach a cell phone, and in such a case, there is no GPS positioning indication at all to the user. FIG. 1 shows an example of no received GPS signal and the response of the cell phone to indicate that there is no received GPS signal, as indicated at 1. The technical information previously described herein is also applicable to other GPS receivers in general.

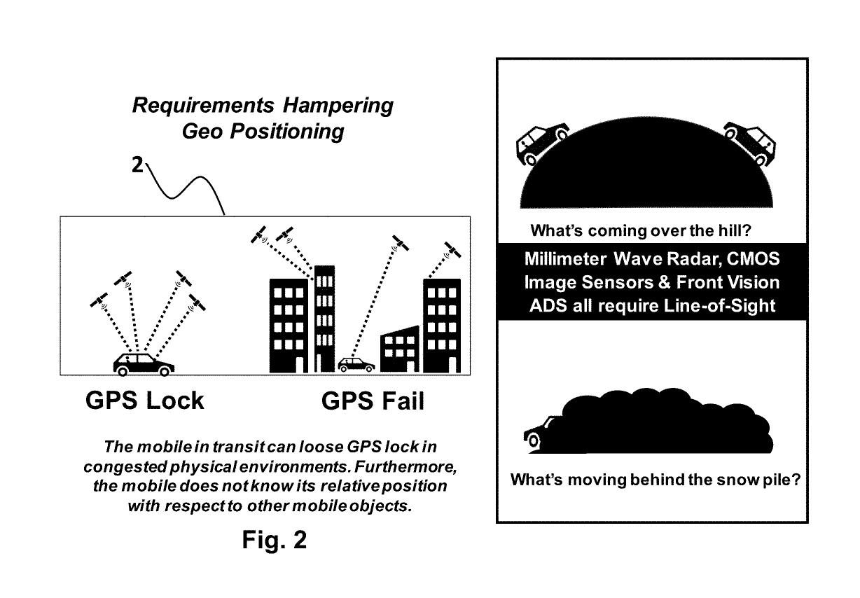

FIG. 2 shows the challenge that GPS and other positional systems face due to their dependence of line-of-sight (LOS) from GPS satellites for their accuracy and actual performance. GPS technology requires that GPS receivers on earth maintain an uninterrupted communication link with four GPS satellites on geosynchronous orbit around the earth. As the transmitted satellite GPS signals from 20000 km in space reach a GPS receiver on earth, the signal is exposed to several measures of degradation. Space radiation (from the sun and cosmos), atmospheric attenuation and distortion, and geometric diffractions are the major culprits for signal degradation. Degraded GPS signals produce wrong or total lack of GPS positioning calculation by GPS receivers. Of the several causes of GPS signal degradation, geometric diffraction is often the most observable one to a user, since it is more observable nearby the GPS receiver the user owns. When there is not a direct LOS between the GPS satellites and the GPS receiver, it means, that as shown in FIG. 2, the signals transmitted by the GPS satellites are being interrupted by physical obstacles (e.g. buildings, as shown in FIG. 2), hence the signals get diffracted and/or reflected by these physical obstacles and may never reach the GPS receiver, and if received by the GPS receiver, the signals will be distorted (i.e. phase and magnitude) which will result in erroneous positioning calculations or no positioning calculations at all. Having said all this, the most important vulnerabilities of GPS signaling are the uncontrollable and unrecoverable factors: malfunctioning satellites, solar flares and solar wind and overall sun output, and the uncertainty of the extraterrestrial space environment.

An important salient feature concerning GPS receiver measurements is that such GPS receiver measurements are individually (singularly) isolated for each receiver. Therefore, each user that has its own GPS receiver can only know its own position, not the position of any other GPS user in its own vicinity, nor it is capable either of knowing the relative position of other GPS users in its vicinity with respect to its own.

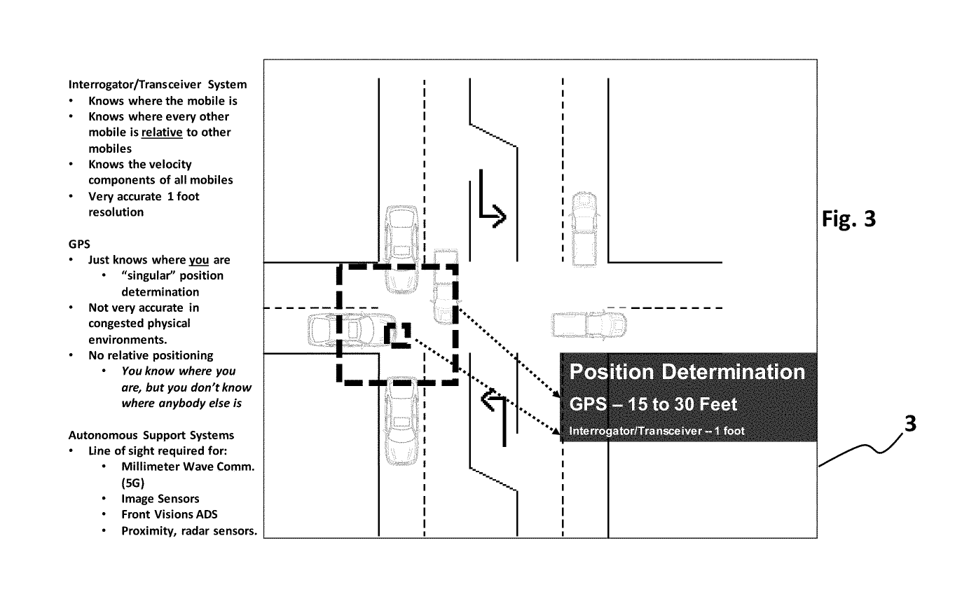

FIG. 3 shows an example of a specific application of the ATPS. The figure shows the simultaneous tracking of multiple mobiles in a highly physically congested workspace. The congested workspace is made up of many mobiles and surrounding physical obstructions 3. The figure shows that if a mobile with a GPS receiver, can establish, in such a congested physical environment, a GPS connection via a direct LOS to four GPS satellites, the accuracy of its true position is between 15 and 30 feet. The same figure also shows that using the ATPS the accuracy of the true position of the same mobile increases significantly to about 1 foot. Because the accuracy of position determination in the ATPS is much superior than GPS, the relative position of multiple mobiles in a congested workspace can also be determined. The ATPS can determine the accurate positioning (to 1 foot) of multiple mobiles very close to each other as shown in the figure. Furthermore, the ATPS can also determine the relative positioning of the multiple mobiles with respect to each other. The GPS positioning system is incapable of determining relative positioning of any mobile with respect to any other mobile and is also incapable of tracking multiple mobiles because it can only provide singular positioning to GPS receivers.

ATPS has the capability to interact with technologies that are presently being used in autonomous mobile systems such as in autonomous mobiles equipped with radar and proximity sensors, vision and image sensors. Eventually, ATPS will interface with 5G wireless systems.

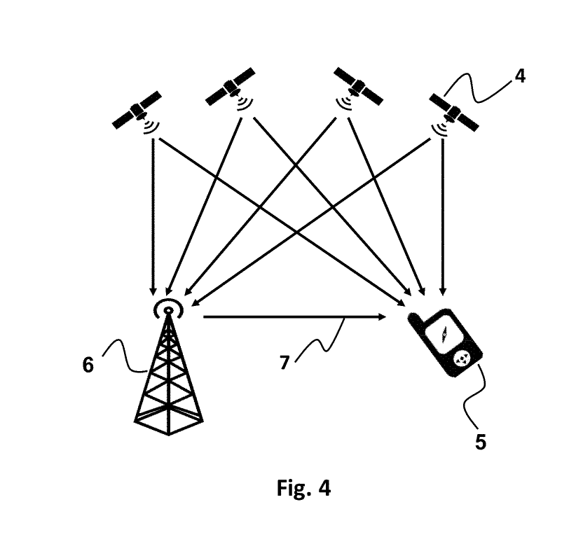

An introduction of how GPS works is shown in FIG. 4. FIG. 4 is shown to introduce some terminology that will also be used in ATPS. As of today, the most successful individual (singular) position determination technology, which is widely used all over the world, and which has been incorporated in most wireless personal communication devices is the global positioning system or GPS. FIG. 4 provides a description of the GPS at the satellite level. The GPS requires four satellites 4 to estimate the location of a user possessing a GPS receiver 5. All four satellites communicate with the ground-based GPS receiver. Of the four satellites, three of the satellites are used to triangulate the location of the GPS receiver, the fourth satellite is used to resolve the time uncertainty incurred by the other three independent satellites. To increase the accuracy of the GPS receiver location 5, the same four satellites also communicate with a receiver at a GPS base station 6 that has a known and fixed GPS location. The base station that has a known GPS location compares its known GPS location with the location revealed by its own GPS measurements. The known errors (differences in x, y and z coordinates) known as differential correction 7 (or correction factor) is applied to the user of GPS receiver 5. The position determination using GPS requires several measurements from different sources (GPS satellites) because position determination is based on triangulation of four received timing signals. However, the accuracy of the received timing signals is limited because the satellites are 20,000 km away and the radio signals are exposed to the everchanging space and atmospheric environment which change the timing of the received signals in addition to other potential degrading factors such as transmitter and receiver noise and physical obstructions, as previously explained. Four distance vectors (D) are calculated using the equation Dn=(186000 miles/sec)*(Tn)*Cf, where T represents the measured timed (in sec) from the GPS satellite to the GPS receiver, n=1, 2, 3, 4 represents the 4 closest GPS satellites to the GPS receiver, and Cf represents the correction factor calculated by the base station with known GPS location and transmitted to the GPS receiver of the user. The triangulation of the four distance vectors on a GIS map produces the receiver GPS position indication.

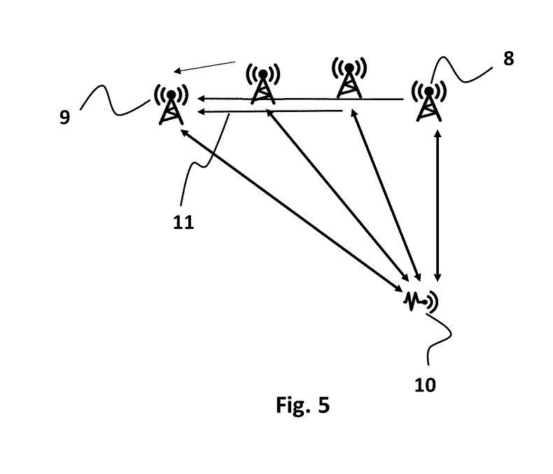

ATPS is not a singular position determination technology as GPS, but rather, ATPS is a ground based wireless positioning system that allows for the simultaneous determination of the position and the tracking of multiple tagged objects. Furthermore, ATPS allows for the flow of location information and tracking information about these tagged objects for further use by other future wireless communication systems (e.g. 5G). FIG. 5 shows the basic elements of the ATPS. At the basic level, with no expansion, the ATPS consists of a cluster of AWI stations. Each cluster contains four AWI stations (or “interrogators”) 8. One of the four AWI stations, chosen as station 9 in FIG. 5, is configured to receive the timing information, provided by the AWR transceiver 10, from the three other AWI stations in the cluster. The chosen AWI station 9 resolves and performs the triangulation calculation needed for the location of the AWR in a GIS. The AWI station 9 chosen to perform triangulation calculation for the cluster is called the Master and the remaining three AWI stations are called the Slaves. However, the AWI station chosen to perform triangulation calculation can be any of the four AWI stations in the cluster since each of the AWI stations in the cluster are identical. Therefore, within a cluster, the AWI station which is first contacted by the AWR transceiver 10 after being interrogated by the AWI stations becomes the Master 9 and assumes the responsibility of performing the triangulation calculation for the cluster. It may usually be the AWI station closest to the AWR transceiver 10 that becomes Master 9. The AWR transceiver 10, however, must be able to communicate with the Master 9 and the Slave AWIs 8 as shown in FIG. 5. The timing information from each slave AWI 8 is passed on to the AWI station 9 chosen as the Master, as indicated at 11, during the tracking of the AWR transceiver 10. The final link in the process is for the Master AWI station 9 to transmit the calculated position information to the AWR transceiver 10 and/or any other recipient and track such positional information continuously and autonomously while the AWR transceiver 10 is within the wireless reach of the cluster.

The AWI stations may be equipped with an embedded fault management system. If the designated Master AWI station later becomes unavailable, another of the remaining three AWI stations becomes the Master and the remaining two AWI stations becomes Slaves AWI stations. If another of the remaining three AWI stations designed as Master becomes unavailable, one of the two remaining AWI station becomes the Master and the other remaining AWI station becomes the Slave. If there is only one AWI station remaining the remaining AWI station is the Master. If a Slave AWI station fails, the Master AWI station may ignore it. Multiple AWRs can be tracked within the cluster which means that depending on the number of AWRs being tracked within the cluster each AWI station can serve both as Master and Slave multiple times.

Each AWI station within the cluster uses different frequencies. The frequency range for all the AWI stations is 3-3.65 GHz and this frequency range is parceled out among the four AWI stations. The bandwidth for each allocated frequency is a minimum 200 Khz and this is also the channel bandwidth for each allocated frequency. As the tagged object being tracked moves away from the cluster, the AWI frequencies are re-used for any other mobile tagged object(s) that enter the range of the cluster. Each AWR is interrogated by an AWI station, and the AWR responds by providing its own identification (ID) and other pertinent information to the AWI station which is needed to assess the AWR positioning. Upon the activation of the AWR transceiver by a AWI station, the AWR transceiver broadcasts its ID number, its transmitted signal strength, and time-stamped time of transmission. Therefore, all AWI stations in the cluster will determine or receive: a) the AWR transceiver ID number, b) the AWR transceiver transmitted signal strength, c) the received signal strength at the AWI station, d) time-stamped time of the transmission by the AWR transceiver, and e) time-stamped time of signal reception by the AWI station. This procedure is repeated for any AWR transceiver that falls within range of any AWI station within the cluster. The multiple AWR transceivers are simultaneously tracked by AWI stations using beamforming smart antennas connected to each AWI station. Tracking involves location determination and velocity (speed with direction, if any) of the tagged object. Each AWI station accurately knows its own fixed GPS location in a geographic information system (GIS). The interaction between an AWI station and an AWR transceiver may be implemented by RFID technology.

AWI station clusters can be positioned strategically to provide coverage in a defined path so that any tagged object in that path can be tracked at its location by four AWI stations. Some fault tolerant conditions may preserve to some degree the fidelity of the ATPS. When the tagged object can only be tracked by one AWI station, the range (not location) of the tagged object can be estimated by the AWI station by assessing only a few measured parameters, but velocity cannot be estimated. When the tagged object can only be tracked by two AWI stations, the location of the tagged object can be partially estimated by assessing a few more parameters from the AWR transceiver and measured by the two AWI stations, and velocity can only be partially estimated. When three AWIs stations are operating, the location can be estimated much more accurately, including velocity estimation, but without the benefit of resolving for accuracy. When the four AWI stations are operating, the location of the AWR transceiver can be accurately estimated using the several parameters from the AWR transceiver and as measured by the four AWI stations. In addition to the several parameters exchanged between the AWR transceiver and the AWI stations, firmware and dedicated hardware in all the AWI stations may use position determination via triangulation. Triangulation uses the time-stamped timing data from the AWR transceiver and the AWI stations, and velocity can also be accurately estimated using triangulation.

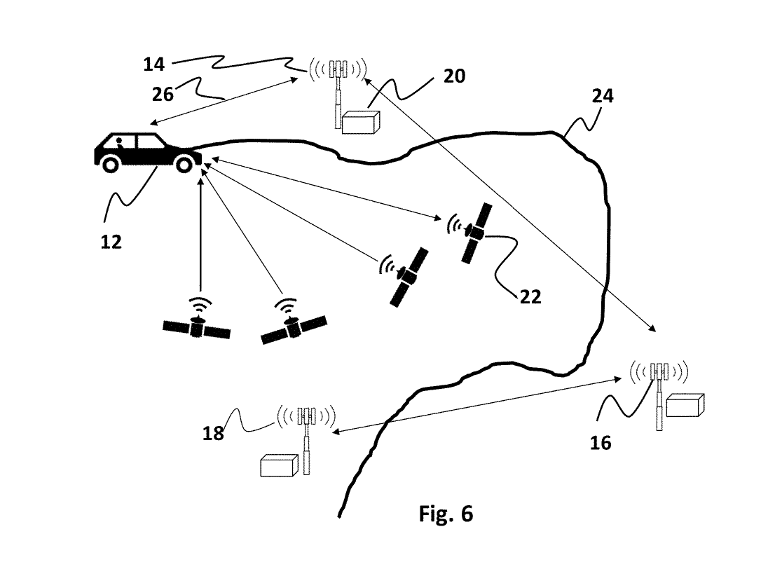

Tracking of objects is an important technology that has gained a lot of applications over the last few years. One of the simplest applications of tracking technology is the use of RFID technology for tracking goods for inventory and evaluation purposes. A much more advanced version of tracking is performed by cell towers as shown in FIG. 6. In the figure, cell towers 14, 16, 18 have the capability to track the phone conversations of a user on a mobile as the mobile moves through far distances if the cell towers are available along the path of the mobile. It is also because of the tracking capability of phone conversations by cell towers that the GPS position of the owner of the cell phone can also be tracked, as cell phones have built in GPS receivers. FIG. 6 shows a mobile unit 12 with a driver having a cell phone and communicating 26 with the nearest cell tower 14 and its base station 20. As the mobile unit moves along the path 24 of FIG. 6, the cell phone conversation and the location of the driver within a GIS are also being tracked by the multiple cell towers 14, 16, and 18. As the mobile goes through the path, the phone conversation and the location of the driver is “handedover” from tower to tower as the mobile unit 12 moves along the path 24. Therefore, as the cell phone conversation is being tracked, the GPS position of the mobile provided by GPS satellites 22 is also been tracked.

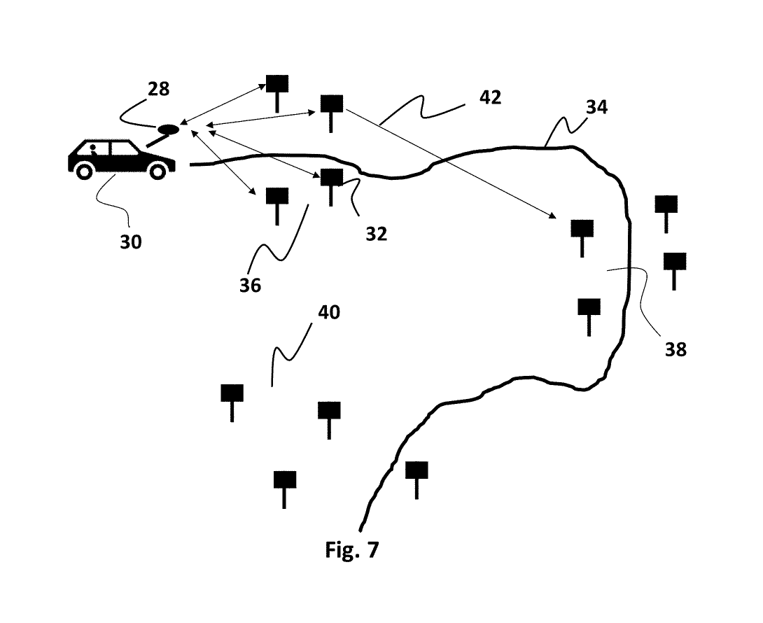

The ATPS uses several clusters of ground-based AWI stations to track autonomously the passage of multiple mobiles with their AWR transceivers, as shown in FIG. 7. In the figure, a mobile unit 30 is equipped with an AWR transceiver 28. The mobile unit equipped with an AWR transceiver will follow path 34. In the path of the mobile unit there are a series of clusters 36, 38, and 40 each including four AWI stations, each AWI station 32 being identical to the others. In certain embodiments of the cluster technology the number of AWI stations in a cluster can be greater than four. As the mobile unit moves along the path 34 it will be moving away from one AWI stations cluster and approaching another AWI stations cluster. Therefore, the ATPS can calculate the position using all available AWI stations in the cluster within range of any given mobile with an AWR transceiver. As the mobile with an AWR transceiver moves out of range from one cluster of AWI stations and enters in the range of another cluster of AWI stations, the AWR transceiver on the mobile will be tracked continuously as tracking transfers from one cluster to another cluster, as indicated at 42. The cluster of AWI stations can be strategically located along a prescribed path for the AWI stations to effectively track an AWR transceiver. Therefore, the extent of the ATPS, in a workspace, is limited only by the number of available clusters of AWI stations in the given workspace. There is no limit to the number of clusters of AWI stations that can be used as the available workspace expands. The cluster of AWI stations can be used in indoor and outdoor workspaces.

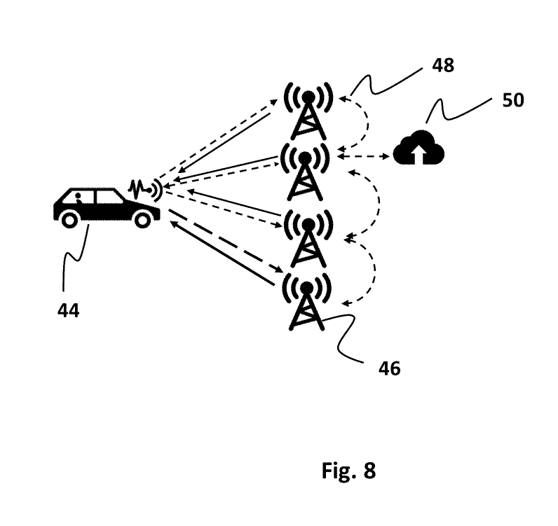

FIG. 8 shows the communications links in the ATPS between ATPS stations and an AWR transceiver on a mobile unit. The figure shows four AWI stations 46 forming a cluster. The figure shows an AWR transceiver on a mobile unit 44. The communication between any AWI station and an AWR transceiver is a two-way communications link as shown. The AWI stations “pings” the AWR transceiver and activates it, and as previously stated, the first AWI station that receives feedback from the AWR transceiver becomes the Master AWI station. The AWR transceivers behave as active tags as it would be in an RFID system. The AWR transceivers are battery powered, but they are dormant unless they become activated by an AWI station. Any AWI station can activate an AWR transceiver and most likely the AWR transceiver will be activated by the AWI station closest to the AWR transceiver. The exchange of information between AWI stations and an AWR transceiver allows for the AWI stations to calculate the location of the AWR transceiver. AWI stations are capable of communication among themselves, as indicated at 48, to exchange timing information as it is in the case of the Master and Slaves AWI stations previously discussed. Furthermore, the AWI stations can also communicate with the outside world to provide position information about the mobiles 44 being tracked. In the figure one AWI station provides in a dedicated fashion internet access with the outside world via the cloud 50 and through a wireless network. As used herein, the term “cloud” may refer to software and services that run on the Internet.

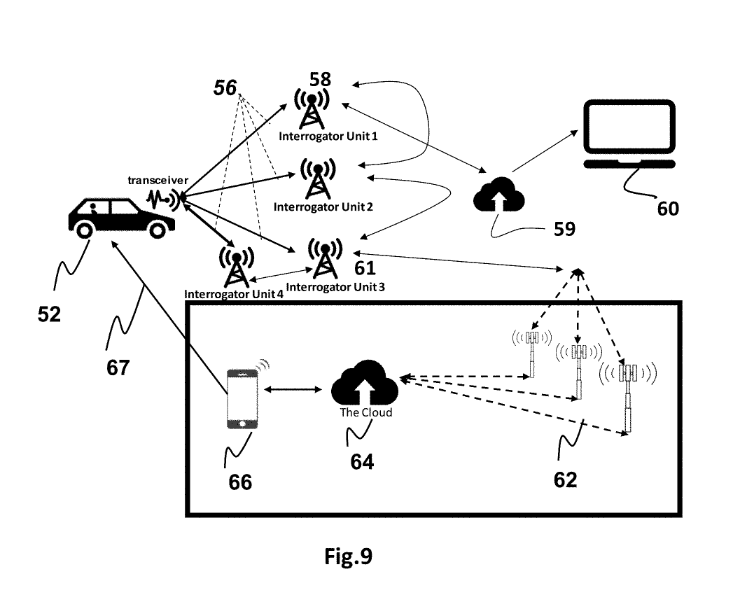

FIG. 9 is an expanded version of FIG. 8 and shows possibilities that exist with ATPS in the wireless environment. FIG. 9 shows the ATPS communicating with the outside world, and this is one of the strengths of the ATPS, its capability to eventually become integrated with 5G. The mobile unit 52 with an AWR transceiver communicates with four AWI stations 56 for position determination. Once the position of the mobile unit has been determined, the information may be delivered to a user (or multiple users) who may use such information for a purpose (or multiple purposes). Therefore, the position information may be sent outside the ATPS. In the figure, one of the AWI stations 58 communicates via WIFI with the Cloud 59 where the position information can be stored for further analysis by multiple potential customers 60, such as 5G. In the figure another AWI station 61 communicates, in a dedicated fashion, with a WiMAX system 62. Once positional data is on the WiMAX system it can be shared in the WWW 64 and even with personal communications devices 66 via WWW 64, such as a personal communications device 66 belonging to the mobile user, as indicated at 67.

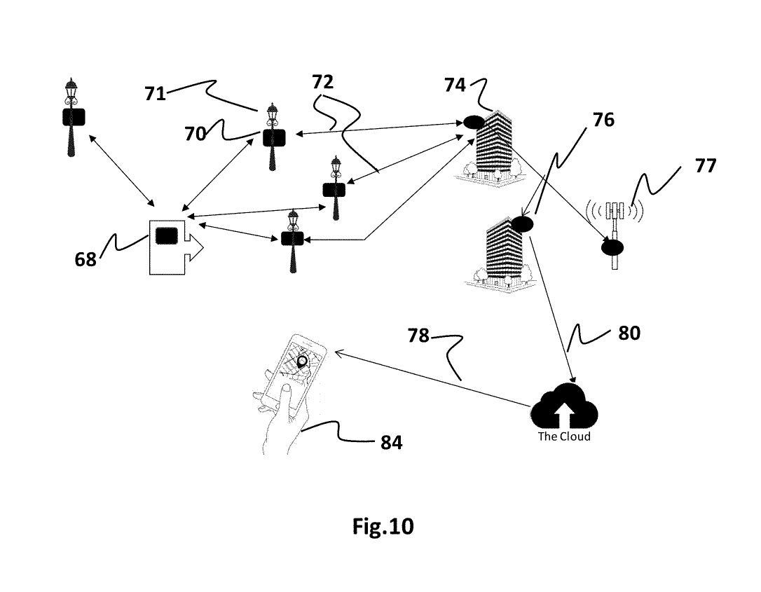

FIG. 10 shows the diverse ways where the AWI hardware can be positioned in a diverse local environment. FIG. 10 shows a generalized AWR transceiver 68 communicating with four AWI stations 70 affixed to lamps posts 71. The figure clearly shows that because of their small size, the AWI stations do not need special fixtures or towers on which to be installed. Rather, an AWI station may be mounted or installed on any tall fixture that has access to electrical power (e.g., solar or wired-in). AWI stations are relatively small, about the size of a half-gallon milk carton, and therefore can be affixed to many types of fixtures, such as buildings 74, 76 and even cell towers 77. As the mobile moves along the workspace environment, AWI stations may keep communications with other AWI stations, as indicated at 72, as part of the handover process. FIG. 10 also shows ATPS stations accessing the Cloud, as indicated at 80, via WIFI, and, from there, communicating via personal wireless devices 84, as indicated at 78. Therefore, a user with a cell phone riding on a mobile equipped with an AWR transceiver may be able to find its position in a workspace as calculated by the AWI stations and may be able to track its position on a continuous basis.

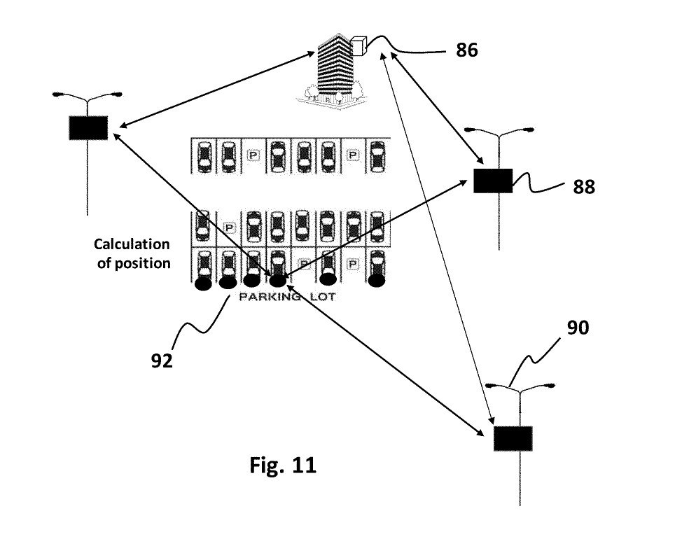

FIG. 11 provides a description of the first of two applications of the ATPS that goes beyond the tracking of mobile tagged objects. FIG. 11 shows an application of the use of ATPS for SmartPark™, a “smart parking” application. In the application of FIG. 11, AWI stations are used to guide vehicles to empty parking slots in a parking structure 92 (indoor or outdoor). Since existing parking structures have a variety of landscapes, FIG. 11 shows that AWI stations are suited for these varieties of landscapes. For example, FIG. 11 shows that AWI stations can be installed in buildings 86 and lamp posts 88, 90 near or inside parking structures. When a car equipped with an AWR transceiver enters a parking structure, the AWR transceiver is activated by the nearest AWI station among a set of AWI stations at the entrance of the parking structure. This set of AWI stations keeps track of cars coming in and going out of the parking structure. Therefore, this set of AWI stations keeps track of the overall number of empty spaces and occupied spaces in the parking structure. As the car moves inside the parking structure it goes past several AWI stations, with all the AWI stations contributing to the coverage of all the parking spaces (some full, some empty) within the parking structure. The car may then be tracked by several AWI stations as it moves. Since there is wireless communication among the AWI stations, the locations of empty parking spaces within the domain of AWI stations is known. This is possible because for each parking space that is occupied by a vehicle, the vehicle has its own AWR transceiver which provides a simple binary indication of empty/full to its closest AWI station. Therefore, as the car moves within the parking structure a given AWI station communicating with the car's AWR transceiver can provide numerical information to the car's AWR transceiver of how many empty spaces (if any) are available within the workspace of a given AWI station. If there are no parking spaces available, the car moves along to the next set of AWI stations, and so on. If there are no empty parking spaces available to the car, then the car may be so instructed before the car enters the parking structure and immediately after the car encounters its first set of AWI stations. Since the AWI stations are capable of tracking time (e.g., via an internal clock), this feature can also be used for dynamically charging parking fees, and such information can be transmitted wirelessly and remotely if a given AWI station can connect to the Cloud via WIFI.

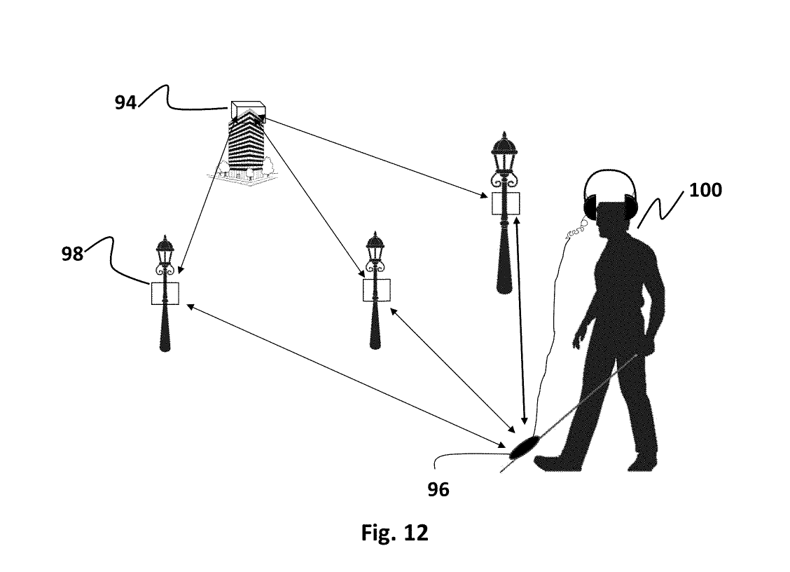

FIG. 12 is similar in principle to the scenario described in FIG. 11, and the same elements are involved: AWI stations in diverse locations 94, 98 and an AWR transceiver 96 serving a blind man 100. The blind man may know his position as he moves through his workspace.

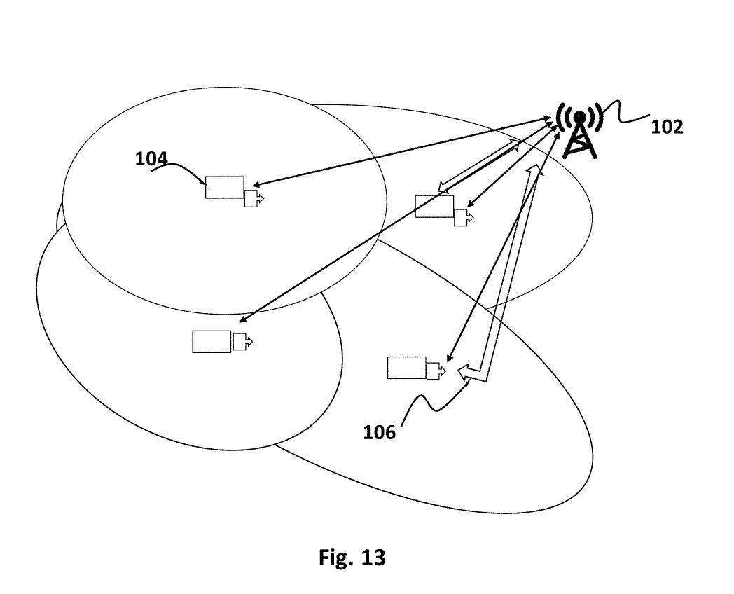

FIG. 13 shows what has already been stated before, that one AWI station can establish communications with multiple AWR transceivers. FIG. 13 shows four AWR transceivers 104 being tracked by a single AWI station 102. The number of AWR transceivers that a single AWI station can track is limited only by channel capacity and not by technology changes. In this example, since four AWI station frequency channels are needed to track a single AWR transceiver, and there are four AWR transceivers in the workspace of FIG. 13, each AWI station must allocate four different frequencies, each with its own bandwidth, to track the four AWR transceivers. Each of the four different frequencies may be associated with four respective frequency channels. Accordingly, there may be sixteen channels involved in tracking these four AWR transceivers. Therefore, for N number of AWR transceivers to be tracked there is a need for 4×N channels. One of the FCC frequency allocations for position determination is the range of 3-3.65 Ghz. If the whole frequency spectrum were to be used (i.e., 650 MHz), and assuming a 200 Khz channel bandwidth with an additional 20 Khz for channel separation, the number of potential channels is 2954, which means that up to 738 AWRs could be tracked. The tracking includes the pinging by AWI stations of AWR transceivers, the response of the AWR transceivers, and the data exchange 106.

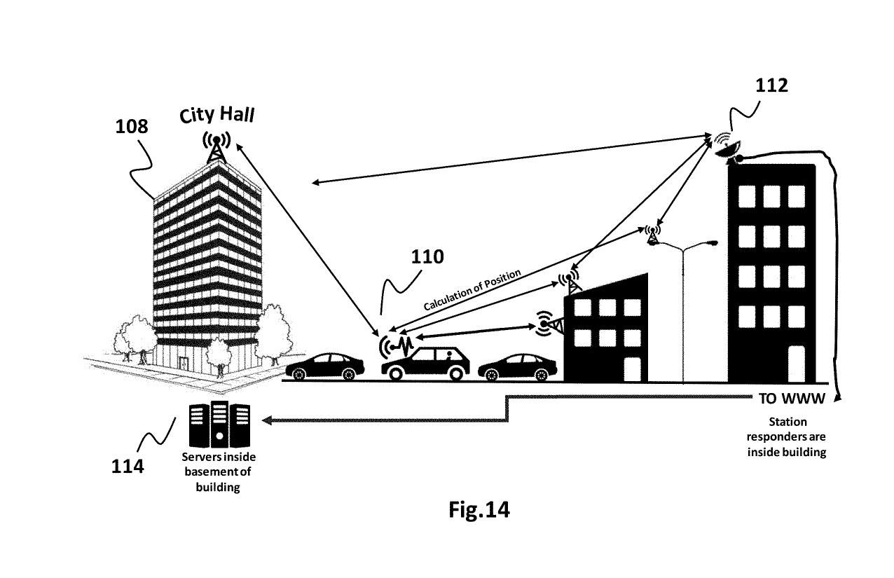

The amount of data exchange and the type of data exchange is tailored to the application, but, at a minimum, the data exchange may include an identifier for an AWI station to be able to contribute to the calculation of the AWR transceiver position. For example, FIG. 14 shows an application where traffic is being monitored near a city government building (e.g., for security purposes). Cars equipped with AWR transceivers (e.g., security or VIP-carrying vehicles) 110 are being tracked by AWI stations 108 which relay position information and possible security data to another station 112 outside the ATPS, and the information and data may be eventually transmitted elsewhere via the WWW. Closing the loop, the same position information and data can be relayed back to the government building 114.

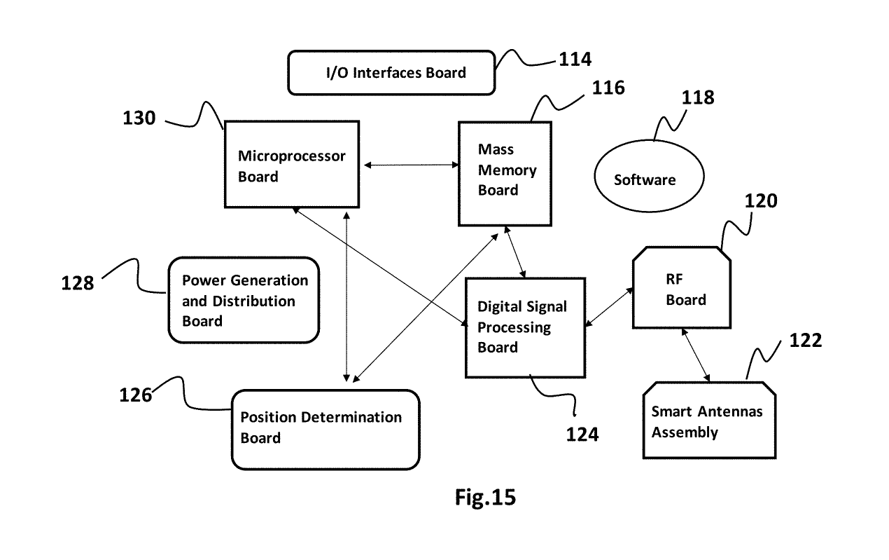

FIG. 15 illustrates the hardware components of the AWI stations. From a hardware point of view the AWI station may be composed of several sets of electronics boards each tailored to perform a specific function. As previously stated, the AWI station may include nine electronic boards: a) transceiver sub-system to communicate with AWRs and other AWI stations. The transceiver sub-system also contains a GPS receiver, b) a microprocessor based sub-system to process data, commands, and implement embedded software algorithms, c) positioning board is the electronics sub-system responsible for calculating the position of the AWR transceiver. It is composed of ASIC and FPGA electronics in addition to interface electronics and firmware, d) a digital signal processing sub-system to process analog and digital data, e) power generation and power distribution sub-system, f) memory sub-system, g) interfaces sub-system to account for multiple interfaces such as remote access, hardware testing, antennas, and external and internal-generated data, h) antennas and their feed network, and i) embedded software.

The power generation and distribution board 128 provides DC power to all the electronics of the AWI station. The power board has the dual capability to receive either AC (power utility mains) or DC (solar) power. The power board is also equipped with a back-up Li-Ion battery. The operating bus voltage to the power board may be 30-36V dc. The microprocessor subsystem 130 is the CPU board for the AWI station. This small board computer may operate with a clock speed greater than 1 GHz. The interfaces board 114 inputs/outputs have hardwired data external interfaces with the outside world (including user interface) and internal interfaces. The transceiver subsystem board 116 contains all the RF electronics for two-way wireless communications with other AWI stations and with the AWR transceivers (via dedicated channels). Another dedicated daughter board contains RF switches 118 for different modes of communications and matching impedance networks 120 for the transceiver antennas. The transceiver antennas constitute another subsystem 122 including smart antennas to create beam forming patterns. The digital signal processing (DSP) subsystem 124 may process large amounts of location and velocity data from multiple AWRs on a continuous basis (tracking). The digital signal processing (DSP) subsystem 124 may also enable the same type of data to be transmitted to other AWI stations. The position determination board 126 assists in the development of algorithms for position and velocity determination. This board contains several ASIC and/or FPGA ICs.

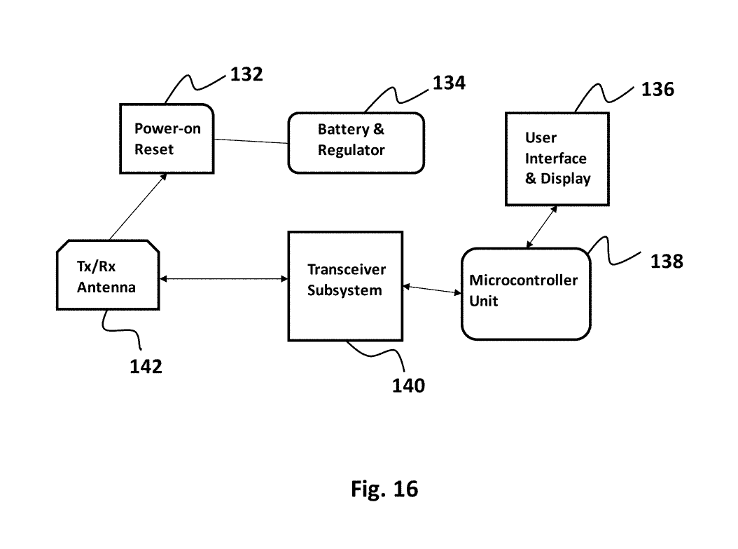

FIG. 16 shows the AWR transceiver hardware architecture. The AWR transceiver for ATPS has a Li-Ion battery 134. However, the battery is only activated via a power-on reset circuit 132 when the AWR transceiver gets pinged by an AWI station. The battery feeds regulator circuits to generate the voltages required by the AWR transceiver electronics. The AWR transceiver stays powered-on as long as the it can detect being pinged by an AWI station, afterwards it turns itself off. This approach allows battery power in the AWR transceiver to remain useful for many months. The AWR transceiver has a dedicated transceiver subsystem 140 responsible for communicating with the AWI stations. The transceiver subsystem connects to a matching network and then to a transmitter/receiver antenna 142. A microcontroller 138 is used for command and processing of AWR data to/from the AWI station. The microcontroller also connects to a user interface 136.

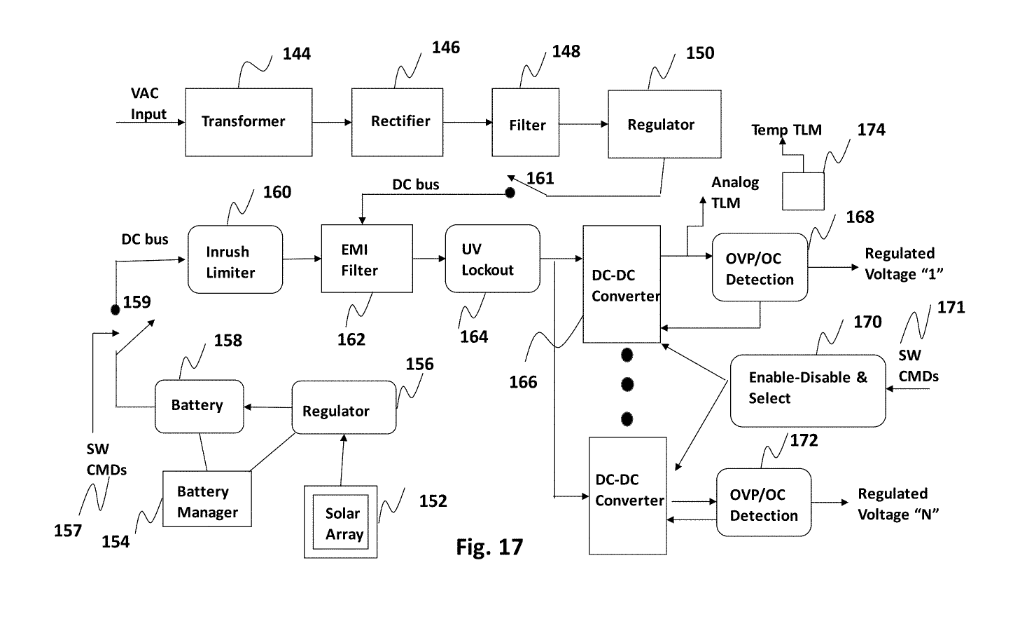

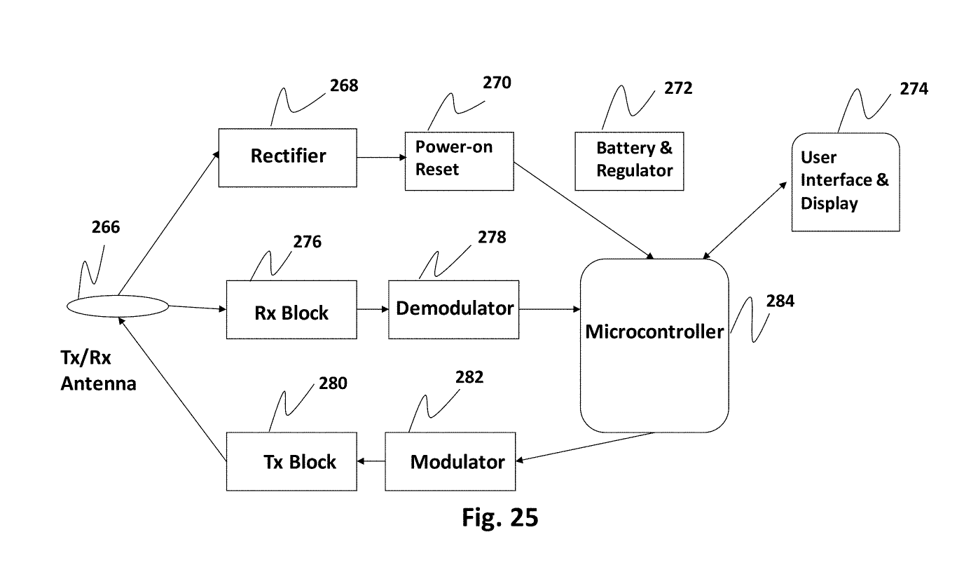

The details of the eight electronic boards comprising the AWI are outlined in FIG. 17 through FIG. 24. The ninth electronic board comprising the AWR is shown in FIG. 25. The nine electronic boards, which in total make up the AWI and AWR assemblies, may all be multilayer boards. Each multilayer board may have at least eight layers, but some boards may reach up to sixteen layers. The boards may include solid ground and solid power copper planes, and the signal layers may be routed between power and ground planes and between ground planes to minimize EMI. There may be four types of multilayer boards (also known as printed circuit boards-PCB) that may be part of the AWI: a) the power board which may accommodate the analog nature of the power electronics converters, b) the digital boards which may accommodate traffic of digital data from digital circuits, c) the mixed-mode analog-digital boards which may accommodate data from both analog and digital circuits, and d) the radio frequency board which may accommodate radio frequency circuits.

FIG. 17 provides a functional description of the power generation board for the AWI. FIG. 17 provides a description of all the electronic functionalities needed to generate the DC voltages for all the electronics in the AWI. The generated DC voltages may be distributed to all the other boards through a backplane. The power board may generate regulated lower-level DC voltages from either a 120V AC (public utility mains) or DC voltages such as those from solar arrays (17-24V). If the AWI uses the public utility mains voltage of 120V AC, the voltage must be first converted to a DC voltage and then regulated to a lower level voltage as shown in FIG. 17. The 120V AC voltage is converted to a DC voltage using a rectification process that involves first a transformer 144 and then a rectifier 146. Any intermittent voltage noise generated by the rectification process is eliminated via a filter 148. In the use of a voltage regulator 150 the resulting DC voltage is down converted to 24V before fed through an EMI filter 162. The purpose of the EMI filter is to protect the main DC bus voltages (bus voltages shown in FIG. 17) from voltage noise. If the AWI uses DC voltage generated from solar array 152, the voltage may again be regulated using a regulator 156 and a storage battery 158. The battery may be used for power storage since solar power is only partially available. The battery also serves as backup power in case of a power supply emergency. Proper charging of the battery is performed via battery manager 154 which provides charge control of the battery. Bus power (˜24V) is channeled to several DC-DC converters 166 to convert the bus voltage to lower levels. The lower level voltages needed are 1.5V, 3.3V, 5V, and 12V. There is a DC-DC converter for the generation of each of these voltages. There are three systems of protection shown in FIG. 17 for the DC-DC converters. These systems of protection disable the DC-DC converters to avoid hardware damage in case of faults and this protection also leverage the capability to re-start the converters and the power supply in general for any type of multiple reasons. Furthermore, these protections also allow to power up in a sequential manner. The first layer of protection is the undervoltage lockout 164. This feature protects the DC-DC converters from being damaged due to a bus voltage that is very low (much less than 24V). The second layer of protection is the overvoltage protection (OVP)/over current (OC) protection 168. Each DC-DC converter has its own OVP/OC as shown in 172. This feature allows the power supply to be protected due to shorts occurring downstream the DC-DC converter including its loads. The last protection feature is the capability to disable the DC-DC converters via software commands 171 which activate enable and disable circuits 170 remotely in the DC-DC converters. The same type of software command is shown on the power switches 159 and 161 which can be disabled or enabled via software commands 157. The switches are used to isolate the two main sources of the bus voltage (solar vs utility mains) depending on the availability. Temperature telemetry (Temp. TLM) 174 of the board is provided via dedicated discrete signal to the analog/digital (A/D) converter of the DSP board.

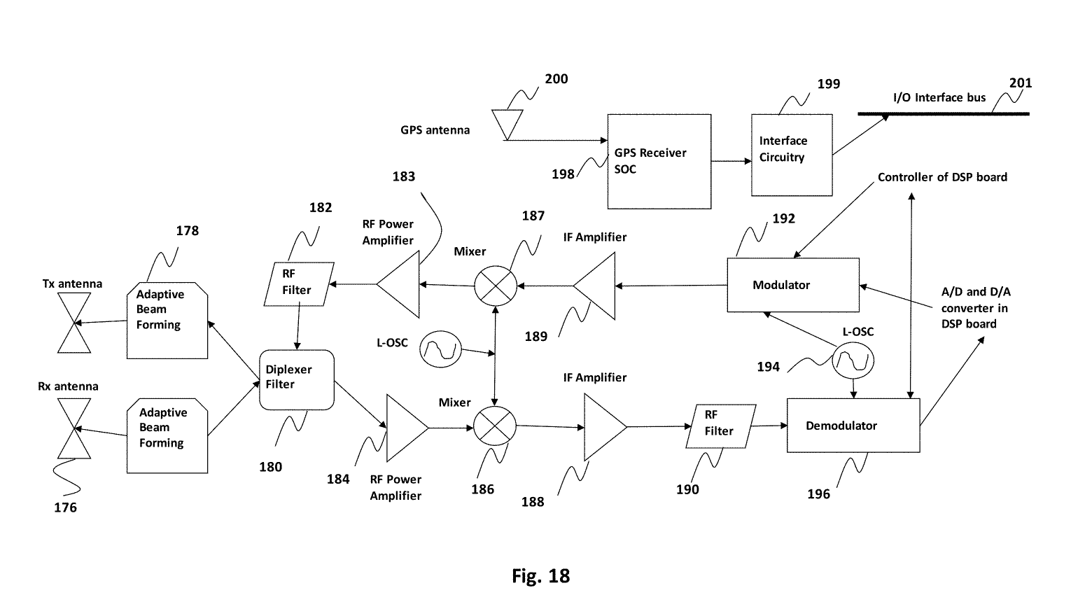

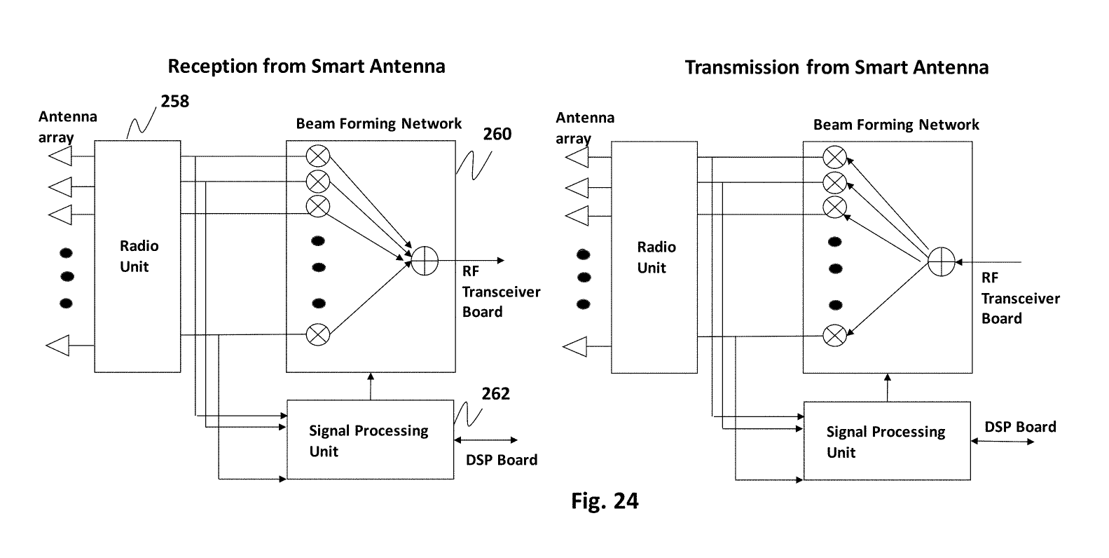

FIG. 18 provides a functional description of the RF transceiver board for the AWI. FIG. 18 provides a description of all the electronic functionalities needed to transmit and receive a RF signal to/from the AWR and the AWI. The RF signal contains the baseband information needed to calculate the position, velocity, and additional data from each AWR. The receiver and transmitter paths contain the smart antennas 176 to communicate with AWRs and AWls. The antenna to be used is an adaptive beam forming antenna whose gain is sufficiently high to acquire signals from an AWR as far as 100 meters away. The beam forming antennas also have electronic scanning capabilities to track multiple AWRs simultaneously. The smart antennas are aided by an adaptive beam forming network 178 which is discussed in more detail in FIG. 24. A diplexer filter 180 is used to properly channel the transmitted and received signals simultaneously. In the receive path, the weak incoming signal is amplified using a low noise and high gain amplifier 184. Using a mixer 186 the amplified signal is down converted in frequency to the intermediate frequency (IF) and is amplified again using an IF amplifier 188. Since the amplification process generates unwanted frequency side bands, the IF signal may be filtered 190 from all other strenuous RF signals. The IF signals contain the baseband information. The demodulator 196 extracts the useful baseband information provided by the AWR. The baseband information is channeled through an analog to digital (A/D) converter before being sent to digital signal processing (DSP) in the DSP board. In the transmit path, baseband digital information from the DSP goes through the digital to analog (D/A) converter and is then modulated 192. It should be observed that a stable frequency of a local oscillator 194 is needed for both the modulator and demodulator to work accurately and also needed for the mixer. In the reverse process, or the transmitted path, the modulated information is amplified through an IF amplifier 189 and upconverted to a much higher frequency using a mixer 187. The resulting modulated high frequency signal is amplified 183. Since the amplification process generates unwanted frequency side bands, the higher frequency modulated signal must be filtered through an RF filter 182. The ready-to-be transmitted signal uses the same diplexer 180 and a transmitter adapting beam forming antenna network 178 which will be discussed in more detail in FIG. 24. The RF transceiver board also contains a GPS receiver in the form of system on a chip (SOC) block 198. The GPS receiver is connected to its own antenna 200 and interface circuitry 199 is provided for GPS data to be sent to the I/O interface bus 201 which sends the data to the DSP board.

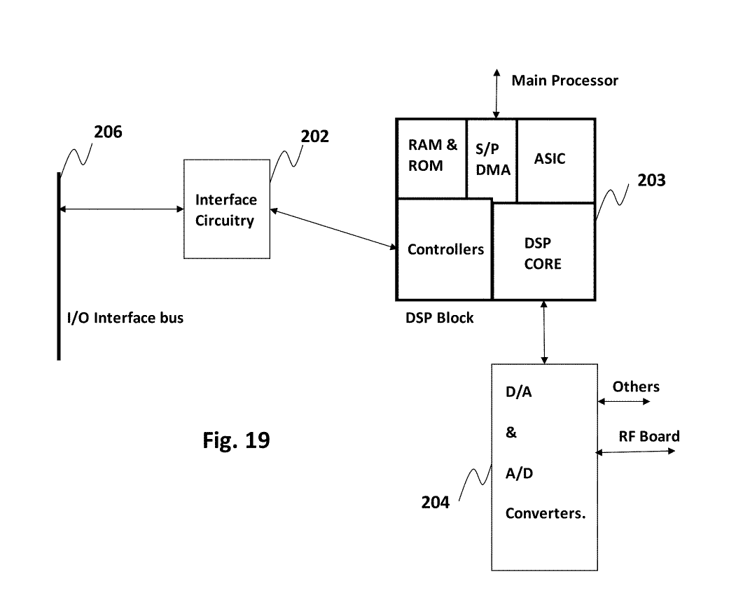

FIG. 19 provides a functional description of the DSP board for the AWI. FIG. 19 provides a description of all the electronic functionalities needed to process all the baseband signals provided by the RF transceiver board and other sources of data from other boards. The DSP board extracts the digital information received from the AWR. The extracted digital information is needed to calculate the position, velocity, and additional data from each AWR. The DSP board also provides the electronics to provide the transceiver RF board with baseband information to be transmitted to the AWR. The work of the A/D & D/A converter 204 was described briefly in FIG. 18. The A/D and D/A converter main function is to process baseband signals coming from and going to the DSP board. The DSP makes the digital information from the baseband signals useful for the computation of position, velocity, and other types of communications between the AWI and AWR. The DSP block 203 contains all the basic elements of the DSP architecture. The DSP block interfaces with the external I/O bus 206 through interface circuitry 202. The DSP block also interfaces with the main processor as shown in FIG. 19. The main processor performs the external control functions acting on the DSP block. The combined elements of the DSP block work as a dedicated central processing unit (CPU) for a specific task. The DSP block processes digitally large quantity of position, velocity, and communication data coming from multiples of AWR on a continuous tracking basis. The complexity of the DSP for this application can be as large as that of processing video data.

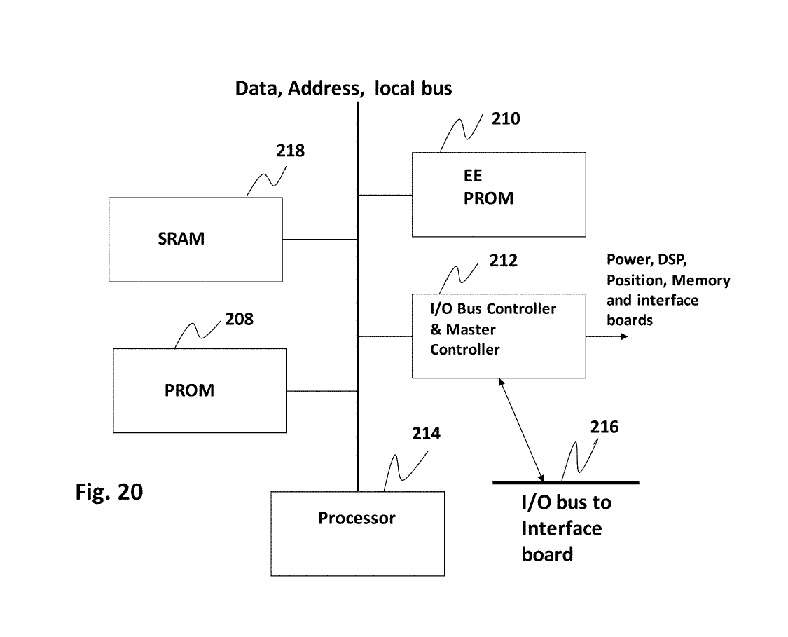

FIG. 20 provides a functional description of the CPU board or main processor board for the AWI. FIG. 20 provides a description of all the electronics functionalities needed to perform the overall control functions of the AWI, which also includes the main control functions for the I/O serial interface bus. The CPU board contains a main processor 214, with its SRAM 218, PROM 208, EEPROM 210, and I/O bus controller 212. The CPU board has self-test diagnostic capabilities and performs in self-test mode, program initialization mode, cold start mode, warm start mode, acquisition and tracking mode. The CPU board may provide I/O interface board servicing via the I/O interface bus 216, DSP control, position measurement control, and mass memory control.

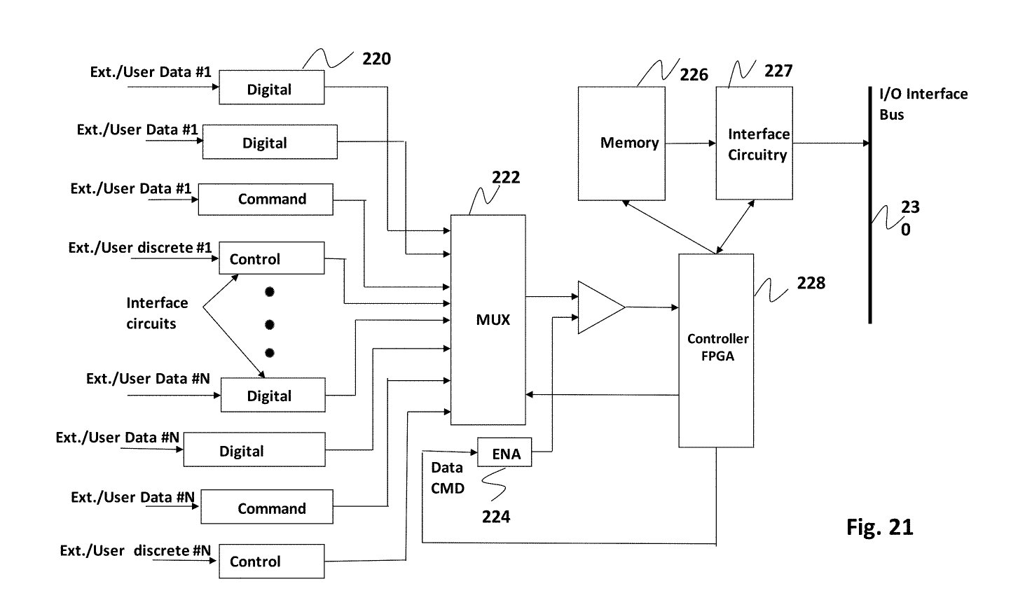

FIG. 21 is the I/O interface board. The I/O interface board is the AWI portal to the outside world. FIG. 21 provides a description of all the electronic functionalities needed to process data from external sources of information. The I/O interface board extracts and manages the multiple sources of information, such as data, commands, and control signals that arrive to AWI from external sources. The extracted and managed information is needed to help AWI with the many functions that need these external inputs. The I/O interface board is also responsible for channeling the required information to the I/O interface bus which is available to most of the boards in the AWI. External sources of information, that at some point may be needed by the AWI, can be of several types. For example, external information can be in the form of digital data (e.g. information from the WWW and other sources), command signals, and control signals which allows for external user interface. The multiple external sources of information are multiplexed 222 so that one source of information is addressed at a time and collisions of data are avoided. The I/O interface controller 228 provides the control function such as enable transmission 224, for the I/O interface board. The controller also is in change of control functions for memory 226 and interface circuitry 227 in the board. All data is eventually channeled through the I/O interface bus 230. The controller design processes large amounts of data that must first be temporarily stored in memory before buffered out via the interface circuitry.

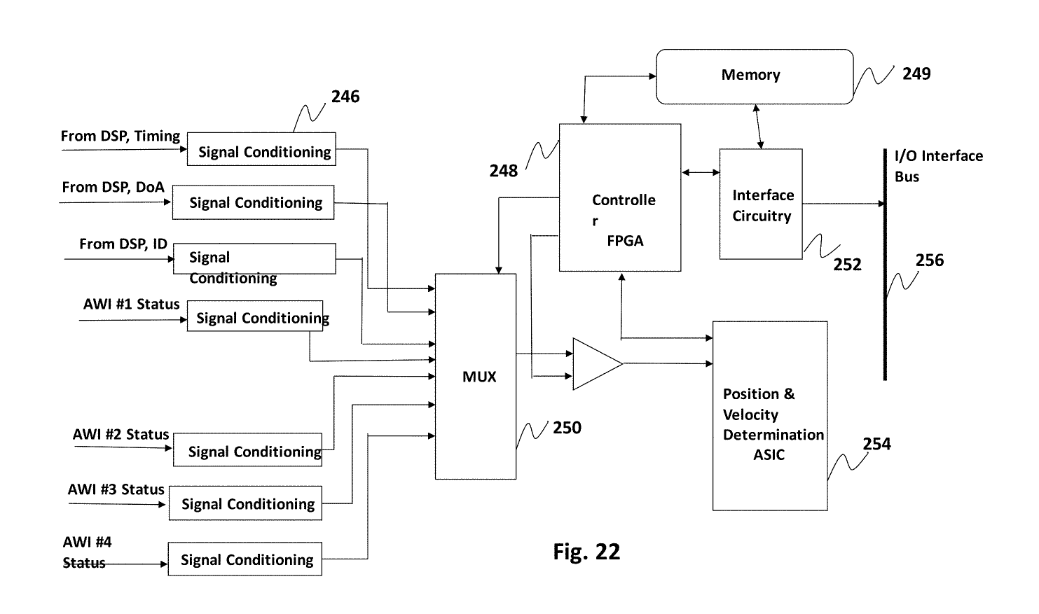

FIG. 22 is the position and velocity determination board. The position and velocity determination board are the AWI board responsible for calculating the position (coordinates), speed, and direction of motion from multiple AWR. The position and velocity determination board are additionally responsible for continuously tracking the multiple AWR. The position and determination board are the most complex boards in the AWI from a design point of view. FIG. 22 provides a description of all the electronic functionalities needed to process data from external sources of information. In FIG. 22 it is shown that signal conditioning circuits 246 interface the position and velocity determination board input signals coming from the DSP board. The DSP board provides four types of data to the position determination and velocity determination board: timing, from which the speed component of the AWR may be obtained; direction of arrival (DoA) from which direction of motion of the AWR, hence velocity, may be calculated; identification of the AWR; and status information from the other three AWls since all four AWIs may work in synch during the tracking of AWR. All inputs to the position and velocity determination board are multiplexed via a multiplexer 250 to avoid data input collisions in the position and velocity determination board. The multiplexer's data flow is under the management of a controller FPGA 248. The controller FPGA 248 also manages the flow of multiplexed data input to the position and velocity determination ASIC, the board memory, and the interface circuitry to the I/O interface bus. The position and velocity determination are provided by an ASIC chip 254. As a large amount of data is processed from multiple AWRs, the data is first stored in memory 249 and is sourced out via interface circuitry 252 to the I/O interface bus 256.

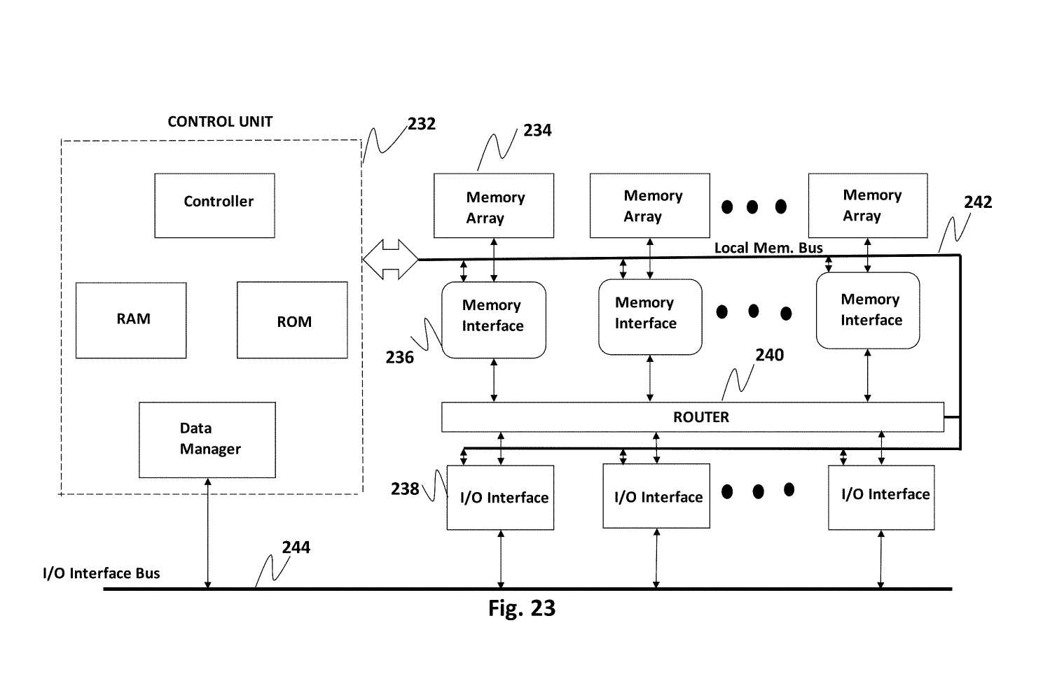

FIG. 23 is the mass memory board for the AWI. The mass memory board is the AWI board responsible for temporary storage of position, velocity, and general data coming into the AWI and flowing through the I/O interface bus. A mass memory board is needed due to the large quantity of data from multiple AWRs which must be tracked simultaneously, plus the potential large quantity of data from external sources and coming through the I/O interface board. The mass memory board has a control unit 232 with its own controller, RAM, ROM, and a data manager which provides a control function to the I/O interface bus 244 and the rest of the board. The other elements of the mass memory, such as the I/O interface 238, memory interface 236, the actual memory components or memory array 234, the internal router 240, and the local memory bus 242 may all be standard design components of mass memory boards.

FIG. 24 shows the main functional components of an adaptive beamforming antenna, a type of smart antenna. The design of adaptive beamforming antennas is composed of three main elements. The radio unit 258 contains the antenna arrays and all the matching antenna feed networks. The beamforming network 260 is responsible for electronic steering the beam in the antenna arrays for maximum gain in the chosen direction. Maximum gain is needed due to the possible weak signals from AWRs from as far as 100 meters away. The very fast beam steering can track multiple AWR simultaneously. The beam steering is possible through as signal processing unit 262 which independently commands the steering of the beam in a closed loop architecture. The outputs and inputs of the adaptive beam forming antenna are channeled via the RF transceiver board. The signal processing unit is under the control of the DSP board.

FIG. 25 shows the architecture of the AWR. The AWR may be a small transceiver with some control functions and a user interface. The AWR main function is to provide its location and direction of motion. The AWR contains a simple omni-directional antenna 266. The transceiver block is composed of a receiver 276 and a demodulator 278 for the receiving path of the transceiver, and a transmitter 280 and modulator 282 for the transmitting path of the transceiver. The transceiver may consist of a single chip. The AWR remains off until pinged by the AWI. Therefore, a power on reset 270 may be in the AWR. The pinged input signal from the AWI may be rectified 268 before the-on reset is useful and can be activated. A battery with its regulator 272 may allow the AWR to perform as an active transceiver with a sustainable power source. The AWR also contains a microcontroller 284 which is powered upon activation of the AWR by the AWI. The microcontroller manages the transceiver and a user interface with its display 274.

What is claimed is:

1. An arrangement for determining a position of an object within a space, the arrangement comprising:
a first wireless transceiver carried by the object and configured to transmit a signal including time information; and
at least four second wireless transceivers fixedly mounted within the space, each of the second wireless transceivers being configured to receive the signal, at least one of the second wireless transceivers being configured to calculate a position of the object based upon the time information and respective times at which each of the second wireless transceivers receives the signal.

2. The arrangement of claim 1 wherein the signal transmitted by the first wireless transceiver comprises a first signal, and wherein the object comprises a motor vehicle, the arrangement comprising a third wireless transceiver communicatively coupled to the at least one second wireless transceiver, the at least one second wireless transceiver being configured to transmit a second signal to the third wireless transceiver, the second signal being indicative of the calculated position of the motor vehicle.

3. The arrangement of claim 2 wherein the third wireless transceiver is configured to transmit a third signal to the Internet, the third signal being indicative of the calculated position of the motor vehicle.

4. The arrangement of claim 1 wherein the first wireless transceiver is configured to transmit a plurality of signals including time information, the at least one second wireless transceiver being configured to calculate a velocity of the object based upon the time information and respective times at which each of the second wireless transceivers receives the signals.

5. The arrangement of claim 1 wherein the time information is indicative of a time at which the first wireless transceiver transmitted the signal.

6. The arrangement of claim 1 wherein the first wireless transceiver and the four second wireless transceivers are autonomous.

7. The arrangement of claim 1 wherein the at least one second wireless transceiver is configured to transmit the position of the object to a personal electronic device of a user of the object via the cloud.

8. An arrangement for informing a moving object of its position within a space, the arrangement comprising:
a first wireless transceiver carried by the moving object and configured to transmit a first signal including time information; and
at least four second wireless transceivers fixedly mounted within the space, each of the second wireless transceivers being configured to receive the first signal, at least one of the second wireless transceivers being configured to calculate a position of the object based upon the time information and respective times at which each of the second wireless transceivers receives the first signal, at least one of the second wireless transceivers being configured to transmit a second signal to the moving object indicative of the calculated position of the object.

9. The arrangement of claim 8 wherein the first wireless transceiver is configured to receive the second signal.

10. The arrangement of claim 8 wherein the object comprises a motor vehicle, the arrangement comprising a third wireless transceiver communicatively coupled to the at least one of the second wireless transceivers, the third wireless transceiver being configured to receive the second signal, the second signal being indicative of the calculated position of the motor vehicle.

11. The arrangement of claim 10 wherein the third wireless transceiver is configured to transmit a third signal to the Internet, the third signal being indicative of the calculated position of the motor vehicle.

12. The arrangement of claim 8 wherein the first wireless transceiver is configured to transmit a plurality of first signals including time information, the at least one of the second wireless transceivers being configured to calculate a velocity of the object based upon the time information and respective times at which each of the second wireless transceivers receives the first signals.

13. The arrangement of claim 8 wherein the time information is indicative of a time at which the first wireless transceiver transmitted the first signal.

14. The arrangement of claim 8 wherein the first wireless transceiver and the four second wireless transceivers are autonomous.

15. The arrangement of claim 8 wherein the at least one of the second wireless transceivers is configured to transmit the position of the object to a personal electronic device of a user of the object via the cloud.

16. An arrangement for managing occupancy of a parking area by vehicles each carrying a first wireless transceiver, the arrangement comprising:
at least four earthbound second wireless transceivers associated within the parking area, each of the second wireless transceivers being configured to receive a respective first signal from each of the vehicles occupying the parking area, each of the first signals including time information; and
an electronic processor communicatively coupled to the four earthbound second wireless transceivers and configured to:
calculate a respective position of each of the vehicles occupying the parking area based upon the time information and respective times at which each of the second wireless transceivers receives the first signal; and
determine which parking spaces of a plurality of parking spaces within the parking area are occupied by the vehicles, the determining being based on the calculated positions of each of the vehicles occupying the parking area.

17. The arrangement of claim 16 wherein the at least four earthbound second wireless transceivers are coupled to a fixed structure.

18. The arrangement of claim 16 further comprising a third wireless transceiver communicatively coupled to the electronic processor, at least one of the second wireless transceivers being configured to transmit a second signal to the third wireless transceiver, the second signal being indicative of which of the parking spaces are occupied by the vehicles.

19. The arrangement of claim 18 wherein the third wireless transceiver is configured to transmit a third signal to the Internet, the third signal being indicative of which of the parking spaces are occupied by the vehicles.

20. The arrangement of claim 16 wherein at least one of the second wireless transceivers is configured to transmit information indicative of which of the parking spaces are occupied by the vehicles to a personal electronic device of a user via the cloud.
